(19) United States
(12) Patent Application Publication
(10) Pub. No.: US 2026/0025889 A1
(43) Pub. Date: Jan. 22, 2026

(54) DIRECT-CURRENT CIRCUIT CONTROL SYSTEM WITH (80 V-260 V) WIDE VOLTAGE INPUT AND LOW VOLTAGE OUTPUT

(71) Applicant: Dongguan Juhan Bio-Photoelectric Co., Ltd., Dongguan (CN)

(72) Inventor: YANZHANG XIE, Dongguan (CN)

(21) Appl. No.: 18/818,827

(22) Filed: Aug. 29, 2024

(30) Foreign Application Priority Data
Jul. 17, 2024 (CN) 202410956985.9

(51) Int. Cl. H05B 45/375; H05B 45/325; H05B 45/39; H05B 47/19

(52) U.S. Cl. CPC H05B 45/375; H05B 45/325; H05B 45/39; H05B 47/19

(57) ABSTRACT

The present invention relates to the technical field of electronic circuits, and disclosed a direct-current circuit control system with (80 V-260 V) wide voltage input and low voltage output, including a power supply circuit (10) and a main control circuit (20). The main control circuit is configured to output at least four pulse-width modulation (PWM) pulse signals, a power input end of the main control circuit (20) is connected to an output end of the power supply circuit (10) and configured to receive a first voltage signal to control the main control circuit (20) to work and output the PWM pulse signals, and the PWM pulse signals are configured to control work of at least one load.

### CROSS-REFERENCE TO RELATED APPLICATIONS

This application claims priority to Chinese Patent Application No. 202410956985.9, filed on July 17, 2024, which is hereby incorporated by reference in its entirety.

### TECHNICAL FIELD

The present invention relates to the technical field of electronic circuits, and particularly relates to a direct-current circuit control system with (80 V-260 V) wide voltage input and low voltage output.

### BACKGROUND

With the development of the times and the progress of science and technology, more and more electronic devices are used in people's daily life, and the electronic devices need to use the mains power supply. The standard of mains power varies from country to country, and the most common mains voltage levels are 110V alternating current and 220V alternating current.

At present, the existing circuits for converting alternating current voltage to direct current voltage in electronic apparatuses are only for the conversion at the same voltage level. Different conversion circuits are required for electronic apparatuses with different power supply voltage levels, which leads to poor compatibility and low functionality of electronic apparatuses and fails to satisfy the market demands.

### SUMMARY

The technical problem to be solved by the present invention lies in providing a direct-current circuit control system with (80 V-260V) wide voltage input and low voltage output that has an adjustable input voltage and desirable reliability for the defect that different conversion circuits are required for electronic apparatuses with different power supply voltage levels, which leads to poor compatibility and low functionality of electronic apparatuses and fails to satisfy the market demands.

The technical solution used by the present invention to solve the technical problem is as follows: a direct-current circuit control system with (80 V-260 V) wide voltage input and low voltage output is constructed, which includes:

a power supply circuit configured to receive a voltage signal input from a mains supply side and perform rectification, filtering, voltage reduction and voltage stabilization on the input voltage signal to output a first voltage signal; and

a main control circuit configured to output at least four pulse-width modulation (PWM) pulse signals, where

the main control circuit at least includes a direct-current (DC)-direct-current (DC) circuit and a main control module,

an input end of the DC-DC circuit is connected to an output end of the power supply circuit, and is configured to receive the first voltage signal and convert the input first voltage signal into a second voltage signal; where

a power input end of the main control module is connected to the output end of the power supply circuit, and is configured to receive the first voltage signal to control the main control module to work to output the PWM pulse signals, and the PWM pulse signals are configured to control work of at least one load.

In some embodiments, the direct-current circuit control system further includes a light-emitting diode (LED) control circuit, where a power input end of the LED control circuit is connected to the output end of the power supply circuit and is configured to receive the first voltage signal and provide a working voltage for the load;

a first signal input end of the LED control circuit is connected to a signal output end of the main control module and is configured to receive a first PWM pulse signal, and the first PWM pulse signal is configured to regulate the first voltage signal to control brightness or color temperature of an LED module; and

a second signal input end of the LED control circuit is connected to a second signal output end of the main control module and is configured to receive a second PWM pulse signal to control the brightness or color temperature of the LED module.

In some embodiments, the LED control circuit includes a constant-current drive circuit,

a power input end of the constant-current drive circuit is connected to the output end of the power supply circuit and is configured to receive the first voltage signal and provide a working voltage for the load;

a first signal input end of the constant-current drive circuit is connected to a first signal output end of the main control module and is configured to receive the first PWM pulse signal; and

a second signal input end of the constant-current drive circuit is connected to the second signal output end of the main control module and is configured to receive the second PWM pulse signal.

In some embodiments, the constant-current drive circuit includes a first constant-current driver and a second constant-current driver,

power input ends of the first constant-current driver and the second constant-current driver are connected to the output end of the power supply circuit separately and are configured to receive the first voltage signal,

a signal input end of the first constant-current driver is connected to a signal output end of the main control module and is configured to receive the first PWM pulse signal, and

a signal input end of the second constant-current driver is connected to another signal output end of the main control module and is configured to receive the second PWM pulse signal.

In some embodiments, the LED control circuit further includes a switch circuit,

one end of the switch circuit is connected to an output end of the first constant-current driver or the second constant-current driver, and

the other end of the switch circuit is connected to an interface of the LED module.

In some embodiments, the main control module at least includes a main controller,

a first signal output end of the main controller is connected to a signal input end of the first constant-current driver, and

a second signal output end of the main controller is connected to a signal input end of the second constant-current driver.

In some embodiments, the direct-current circuit control system further includes a motor control circuit,

a signal input end of the motor control circuit is connected to the signal output ends of the main control module separately and is configured to receive a control signal, and

an output end of the motor control circuit is connected to an input end of a motor.

In some embodiments, the motor control circuit includes a current sampling circuit,

a detection end of the current sampling circuit is connected to the signal input end of the motor control circuit, and

an output end of the current sampling circuit is connected to a current feedback end of the main control module.

In some embodiments, the main control circuit further includes a voltage detection circuit,

one end of the voltage detection circuit is connected to the output end of the power supply circuit, and

the other end of the voltage detection circuit is connected to a voltage feedback end of the main control module.

In some embodiments, the main control circuit further includes a wireless receiving circuit,

a transmitting end of the wireless receiving circuit is connected to a receiving end of the main control module, and

a receiving end of the wireless receiving circuit is connected to a transmitting end of the main control module.

The direct-current circuit control system with (80 V-260 V) wide voltage input and low voltage output of the present invention includes the power supply circuit and the main control circuit. The power input end of the main control module is connected to the output end of the power supply circuit, and is configured to receive a 24 V voltage signal to control the main control circuit to work to output the PWM pulse signals, and the PWM pulse signals are configured to control work of at least one load. Compared with the prior art, a plurality of voltage signals (such as 24 V and 5 V) can be output through cooperation of the DC-DC circuit and the main control module. Different loads are controlled through the plurality of PWM pulse signals, so as to match voltage ranges of different countries or regions, and alternating-current voltages in a wide range can be adapted, so as to be applied to most electronic products. On the one hand, the problem that different conversion circuits are required for electronic apparatuses with different power supply voltage levels, which leads to poor compatibility and low functionality of electronic apparatuses and fails to satisfy the market demands can be solved effectively; and on the other hand, by setting a constant-current integrated circuit (IC) module, the stroboscopic problem generated by white light and yellow light when the LED module is turned on is avoided.

### BRIEF DESCRIPTION OF DRAWINGS

The present invention will be further described below with reference to the accompanying drawings and examples. In the figures:

FIG. 1 is a schematic circuit diagram of an example of a power supply circuit according to the present invention.

FIG. 2 is a schematic circuit diagram of an example of a main control circuit according to the present invention.

FIG. 3 is a schematic circuit diagram of an example of a motor control circuit according to the present invention.

FIG. 4 is a schematic circuit diagram of an example of a light-emitting diode (LED) control circuit according to the present invention.

### DETAILED DESCRIPTION OF THE EMBODIMENTS

For a clearer understanding of technical features, objectives and effects of the present invention, specific embodiments of the present invention will be described in detail with reference to the accompanying drawings.

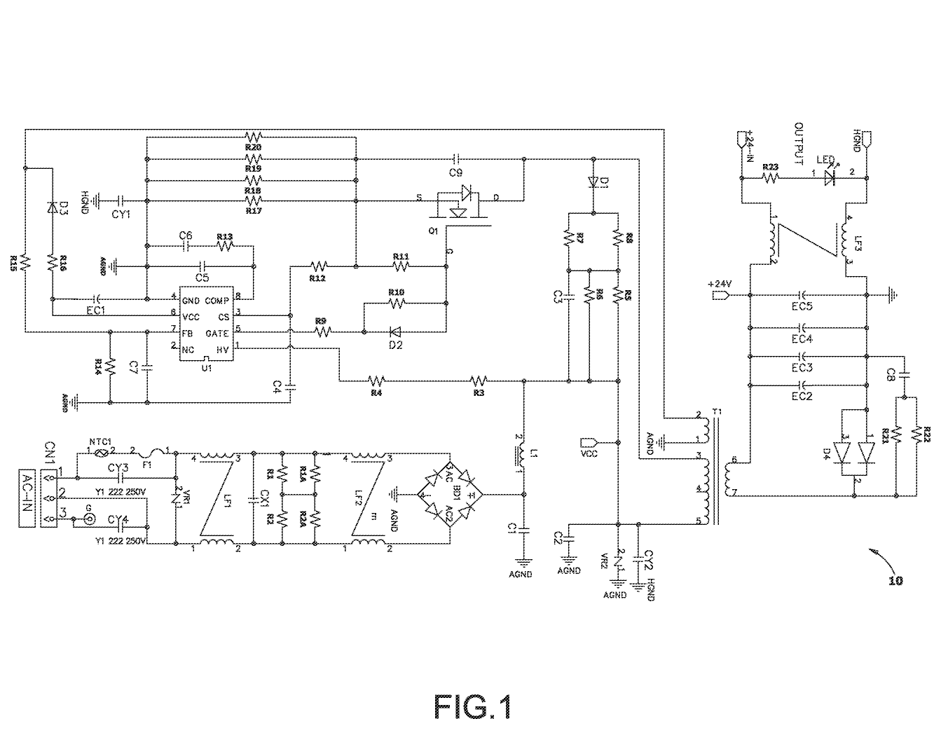

As shown in FIGS. 1-4, in a first example of a direct-current circuit control system with (80 V-260 V) wide voltage input and low voltage output of the present invention, the direct-current circuit control system with (80 V-260 V) wide voltage input and low voltage output includes a power supply circuit 10, a main control circuit 20, a motor control circuit 30 and a light-emitting diode (LED) control circuit 40.

The main control circuit 20 is provided with at least a main control module 210, a direct-current (DC)-direct-current (DC) circuit 220, a voltage detection circuit 230, a wireless receiving circuit 240, a burning port module 250 and a buzzer circuit 260.

The motor control circuit 30 includes an overcurrent comparison module 310, a current sampling circuit 320, and a motor control module 330.

The LED control circuit 40 includes a constant-current drive circuit 410 and a switch circuit 420.

Specifically, the power supply circuit 10 is configured to receive a voltage signal input from a mains supply side and perform rectification, filtering, voltage reduction and voltage stabilization on the input voltage signal to output a first voltage signal.

In the example, the first voltage signal is 24 V.

The main control module 210 has functions of calculating, outputting a plurality of pulse-width modulation (PWM) driving signals, outputting a plurality of control signals, and adjusting a duty ratio of the PWM driving signals, and is configured to control working states of the LED module and the motor (not shown).

The DC-DC circuit 220 is configured to receive a 24 V voltage signal output by the power supply circuit 10, and output a second voltage signal by reducing a voltage. A range of the second voltage signal is 0 V-36 V.

In the example, the second voltage signal is 5 V.

The voltage detection circuit 230 is configured to detect the 24 V voltage signal output by the power supply circuit 10, perform voltage division on the 24 V voltage signal, and output the voltage signal subjected to voltage division to the main control module 210.

The wireless receiving circuit 240 is configured to receive a wireless signal input by an external remote controller and then perform signal interaction with the main control module 210.

The buzzer circuit 260 is configured to output a warning signals.

The burning port module 250 serves as a signal interaction interface between the main control module 210 and an external computer. The external computer burns a program into the main control module 210 through the burning port module 250.

The overcurrent comparison module 310 is configured to receive a current signal obtained by the current sampling circuit 320, perform voltage division on the current signal, and feed back the current signal subjected to voltage division to the main control module 210.

The current sampling circuit 320 is configured to obtain a current signal when the motor is working, and feed back the current signal to the main control module 210.

The motor control module 330 is configured to control a working state of the motor.

The LED control circuit 40 is configured to receive the PWM pulse signal input by the main control module 210, so as to control brightness and adjust color temperature of the LED module.

Specifically, the power supply circuit 10 is configured at a front end of a single-stage control circuit, and is configured to receive a voltage signal (-220 V) input from a mains supply side and perform rectification, filtering, voltage reduction, and voltage stabilization on the input voltage signal to output the first voltage signal (24 V).

Specifically, as shown in FIG. 1, a voltage signal (-220 V) is input to a rectifier bridge BD1 by means of a fuse F1 and common mode inductor coils (LF1, LF2), rectified and output by means of the rectifier bridge BD1, filtered by means of a first capacitor C1, a first inductor L1 and a second capacitor C2, and divided two paths. One path is input to a power end (corresponding to pin 1) of a flyback constant-voltage controller U1 by means of a third resistor R3 and a fourth resistor R4, to control work of the flyback constant-voltage controller and output a control signal.

A gate of a first metal oxide semiconductor (MOS) transistor Q1 is connected to an anode of a second diode D2. A cathode of the second diode D2 is connected to one end of a ninth resistor R9. The other end of the ninth resistor R9 is connected to a signal output end (corresponding to pin 8) of the flyback constant-voltage controller U1.

The other path is input into one end (corresponding to pin 5) of a primary winding of a transformer T1. A drain of the first MOS transistor Q1 is connected to one end (corresponding to pin 3) of the primary winding. A source of the first MOS transistor Q1 is connected to a common end by means of a seventeenth resistor R17 and a Y capacitor CY1.

When a control signal output by the flyback constant-voltage controller U1 is at a high level. The first MOS transistor Q1 is controlled to be connected, the primary winding of the current signal transformer T1 is coupled to a secondary winding thereof. The voltage signal is rectified by a diode D4, filtered by a capacitor EC2, a capacitor EC3, a capacitor EC4, a capacitor EC5 and a common mode inductor coil LF3, and output as a +24 V voltage signal for use by subsequent circuits (such as the main control module 210 and the LED control circuit 40).

Further, a signal input end of the DC-DC circuit 220 is connected to an output end of the power supply circuit 10 and is configured to receive an input 24 V voltage signal and reduce a voltage to output a 5 V voltage signal, so as to control a buzzer BZ1 of the buzzer circuit 260 to work.

Specifically, the main control module 210 is configured to output at least four PWM pulse signals.

A power input end (+24 V) of the main control module 210 is connected to an output end (+24 V) of the power supply circuit 10 and is configured to receive a 24 V voltage signal. The 24 V voltage signal is configured to control the main control module 210 to work, so as to output the plurality of PWM pulse signals. The output PWM pulse signals are configured to control the work of at least one load (such as the LED module, the buzzer BZ1, the motor, etc.).

By using the technical solution, a plurality of voltage signals (such as 24 V and 5 V) can be output through cooperation of the DC-DC circuit and the main control module 210. Different loads are controlled through the plurality of PWM pulse signals, so as to match voltage ranges of different countries or regions, and adapted alternating-current voltages in a wide range can be increased, so as to be applied to most electronic products. Compatibility of voltage levels of an electronic apparatus can be improved. PWM pulse analog signals are used to control stable voltage output. On the one hand, the problem that different conversion circuits are required for electronic apparatuses with different power supply voltage levels, which leads to poor compatibility and low functionality of electronic apparatuses and fails to satisfy the market demands can be solved effectively.

On the other hand, by setting a constant-current integrated circuit (IC) module, the stroboscopic problem generated by white light and yellow light when the LED module is turned on is avoided.

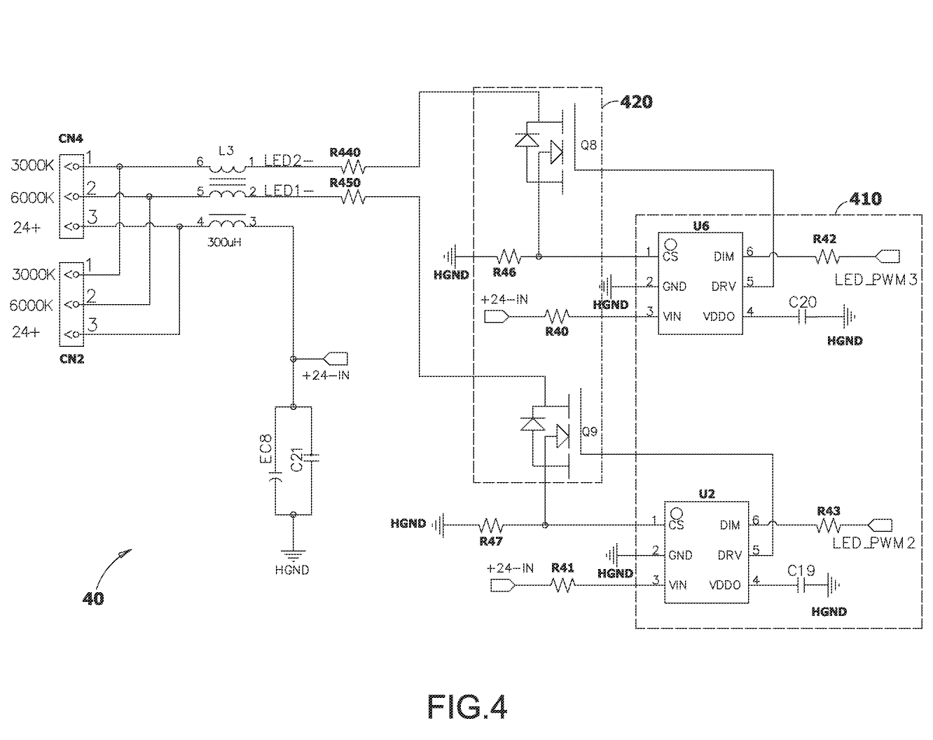

In some embodiments, as shown in FIG. 4, in order to improve performance of the circuit, the LED control circuit 40 may be arranged in the circuit. A power input end (24 V) of the LED control circuit 40 is connected to the output end (+24 V) of the power supply circuit 10 and is configured to receive the 24 V voltage signal. An output end (corresponding to CN4) of the LED control circuit 40 is connected to a signal end of the LED module (not shown) and is configured to provide a working voltage for the LED module (not shown).

A first signal input end of the LED control circuit 40 is connected to a signal output end of the main control module 210 and is configured to receive a first PWM pulse signal (LED-PWM2). The first PWM pulse signal (LED-PWM2) is configured to regulate the 24 V voltage signal to control brightness or color temperature of the LED module.

A second signal input end of the LED control circuit 40 is connected to a second signal output end of the main control module 210 and is configured to receive a second PWM pulse signal (LED-PWM3) to control the brightness or color temperature of the LED module.

The main control module 210 can adjust a duty ratio of the PWM pulse signal, such that the first PWM pulse signal (LED-PWM2) and the second PWM pulse signal (LED-PWM3) can be configured to adjust the brightness or color temperature of the LED module separately, thereby avoiding the stroboscopic problem generated when white light and yellow light are turned on at the same time.

For example: warm light: 2700 K-4500 K;

pure white light: 4500 K-6500 K; and

cold white light: above 6500 K.

In some embodiments, as shown in FIG. 4, the LED control circuit 40 includes a constant-current drive module 410. A power input end (corresponding to pin 3) of the constant-current drive module 410 is connected to the output end (24V) of the power supply circuit 10 and is configured to receive the 24 V voltage signal and provide a working voltage for the LED module.

As shown in FIG. 4, a first signal input end (corresponding to pin 6) of the constant-current drive module 410 is connected to a signal output end (corresponding to pin 21) of the main control module 210 by means of a forty-third resistor R43 and is configured to receive the first PWM pulse signal (LED-PWM2).

A second signal input end (corresponding to pin 6) of the constant-current drive module 410 is connected to the second signal output end (corresponding to pin 20) of the main control module 210 by means of a forty-second resistor R42 and is configured to receive the second PWM pulse signal (LED-PWM3).

Specifically, as shown in FIG. 4, the constant-current drive module 410 includes a first constant-current driver U2 and a second constant-current driver U6 and is configured to adjust a constant-current state of an output current, so as to adjust the brightness of the LED module.

A first signal input end (corresponding to pin 6) of the first constant-current driver U2 is connected to a signal output end (corresponding to pin 21) of the main control module 210 by means of the forty-third resistor R43 and is configured to receive the first PWM pulse signal (LED-PWM2). The PWM pulse signal (LED-PWM2) can be configured to control the brightness or color temperature of the LED module.

A first signal input end (corresponding to pin 6) of the second constant-current driver U6 is connected to a second signal output end (corresponding to pin 20) of the main control module 210 by means of the forty-second resistor R42 and is configured to receive the second PWM pulse signal (LED-PWM3). The PWM pulse signal (LED-PWM3) can be configured to for control the brightness or color temperature of the LED module.

Output ends of the first constant-current driver U2 and the second constant-current driver U6 are connected to a signal input end of the switch circuit 420 separately.

The switch circuit 420 has at least a second MOS transistor Q8 and a third MOS transistor Q9. N-channel MOS transistors are selected as the MOS transistors and have a switch function.

An output end (corresponding to pin 5) of the first constant-current driver U2 is connected to a gate of the third MOS transistor Q9.

A drain of the third MOS transistor Q9 is connected to a first interface CN2 and a second interface CN4 by means of a resistor R450 and an inductor L3.

A source of the third MOS transistor Q9 is connected to a common end by means of a forty-seventh resistor R47.

Further, an output end (corresponding to pin 5) of the second constant-current driver U6 is connected to a gate of the second MOS transistor Q8.

A drain of the second MOS transistor Q8 is connected to the first interface CN2 and the second interface CN4 by means of a resistor R440 and the inductor L3.

Power input ends of the first interface CN2 and the second interface CN4 are connected to the output end (+24 V) of the power supply circuit 10 separately. The 24 V voltage signal provides working power for the LED module.

A source of the second MOS transistor Q8 is connected to the common end by means of a forty-sixth resistor R46.

The second constant-current driver U6 and the first constant-current driver U2 control the duty ratio of the PWM pulse signal, so as to control connection states of the second MOS transistor Q8 and the third MOS transistor Q9.

When the first PWM pulse signal input by the main control module 210 is at a high level, the third MOS transistor Q9 is controlled to be connected, and 24 V is applied to the inductor L3. When the input first PWM pulse signal is at a low level, the third MOS transistor Q9 is controlled to be disconnected. When the third MOS transistor Q9 is connected from disconnection, the input 24 V voltage signal is superimposed with a voltage on the inductor L3, such that voltages of the first interface CN2 and the second interface CN4 are increased, and a voltage of the LED module is increased, such that the brightness or color temperature of the LED module is controlled.

The second MOS transistor Q8 and the third MOS transistor Q9 work on the same principle, which will not be described in detail.

The main control module 210 can adjust the duty ratio of the first PWM pulse signal (LED-PWM2) and the second PWM pulse signal (LED-PWM3) to adjust the color temperature and brightness of the LED module.

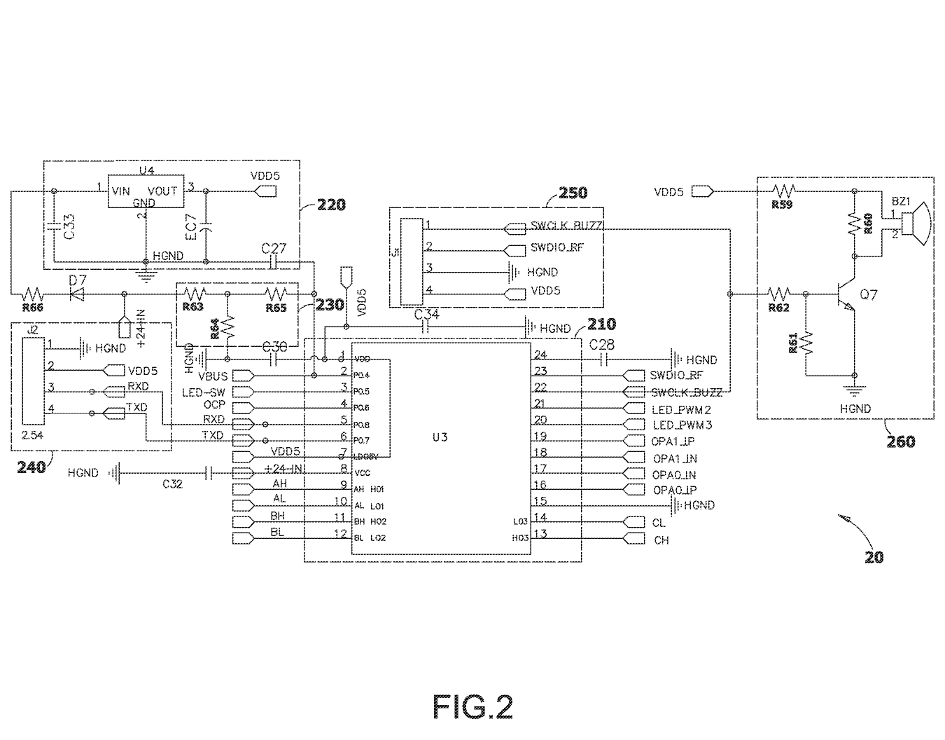

In some embodiments, as shown in FIG. 2, the main control module 210 at least includes a main controller U3, which is a core of the circuit and has functions of signal processing, analyzing and outputting a plurality of PWM pulse signals.

Specifically, a first signal output end (corresponding to pin 21) of the main controller U3 is connected to a signal input end (corresponding to pin 6) of the first constant-current driver U2 by means of the forty-third resistor R43 and is configured to output the first PWM pulse signal.

A second signal output end (corresponding to pin 20) of the main controller U3 is connected to an input end (corresponding to pin 6) of the second constant-current driver U6 by means of the forty-second resistor R42 and is configured to output the second PWM pulse signal.

When the first PWM pulse signal and the second PWM pulse signal are both at high levels, the constant-current driver (U2/U6) is controlled to work to increase the output voltage signal, so as to adjust the brightness and color temperature of the LED module.

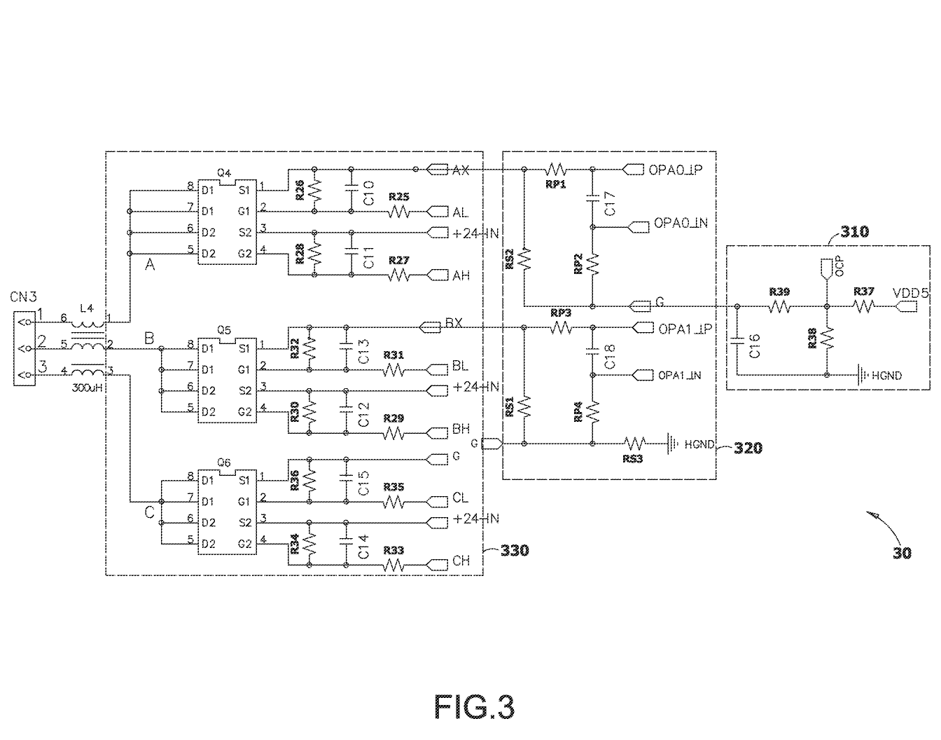

In some embodiments, as shown in FIG. 3, in order to improve the performance of the control circuit, a motor control module 330 may be arranged in the motor control circuit 30 and is configured to control a working state (for example, switching, speed regulation) of the motor.

Specifically, the signal input ends (corresponding to AH/BL/CL) of the motor control module 330 are connected to the signal output ends (corresponding to AH/BL/CL) of the main controller U3 respectively and are configured to receive a control signal.

Power input ends (corresponding to +24-IN) of the motor control module 330 are separately connected to the output end (+24 V) of the power supply circuit 10 and are configured to receive the 24 V voltage signal. The 24 V voltage signal is configured to control the work of the motor.

An output end (corresponding to CN4) of the motor control module 330 is connected to an input end of the motor.

When the control signal output by the main controller U3 is at a high level, the motor control module 330 is controlled to be connected, so as to output a working voltage to the motor.

In some embodiments, as shown in FIG. 3, the direct-current circuit control system further includes a current sampling circuit 320. Detection ends (corresponding to OPA0-IN and OPA1-IN ends ) of the current sampling circuit 320 is connected to the signal input ends (corresponding to OPA0-IP and OPA1-IP ends) of the motor control module 330 and are configured to obtain a current signal when the motor is working.

Output ends (corresponding to OPA0-IP and OPA1-IP ends) of the current sampling circuit 320 are connected to current feedback ends (corresponding to pins 16-19) of the main controller U3 (belonging to the main control module 210) to feed back the current signal to the main controller U3.

In some embodiments, as shown in FIG. 3, the direct-current circuit control system further includes an overcurrent comparison module 310. A detection end (corresponding to end G) of the overcurrent comparison module 310 is connected to one end of the current sampling circuit 320 and is configured to obtain the current signal.

One end of the overcurrent comparison module 310 is connected to the output end (corresponding to 5 V) of the DC-DC circuit 220 and is configured to obtain a reference signal, compare the current signal with the reference signal, and output a comparison result to the main controller U3.

The other end (corresponding to the OCP end) of the overcurrent comparison module 310 and one end (corresponding to pin 4) of the main controller U3 are configured to receive the comparison result and control the working state of the motor according to the comparison result.

In some embodiments, as shown in FIG. 2, the direct-current circuit control system further includes a voltage detection circuit 230. One end (corresponding to 5 V) of the voltage detection circuit 230 is connected to the output end (corresponding to 5V) of the DC-DC circuit 220.

The other end (corresponding to the VBUS end) of the voltage detection circuit 230 is connected to a voltage feedback end (corresponding to pin 2) of the main controller U3 (belonging to the main control module 210).

Specifically, the voltage detection circuit 230 includes a sixty-third resistor R63, a sixty-fourth resistor R64 and a sixty-fifth resistor R65. The sixty-third resistor R63 is connected in series to the sixty-fifth resistor R65 and then connected in parallel to the sixty-fifth resistor R64.

The 5 V voltage signal is subjected to voltage division by the sixty-third resistor R63, the sixty-fourth resistor R64 and the sixty-fifth resistor R65, then is output to the main controller U3, and compared by the main controller U3.

In some embodiments, as shown in FIG. 2, the direct-current circuit control system further includes a wireless receiving circuit 240. A transmitting end (TXD) of the wireless receiving circuit 240 is connected to a receiving end (corresponding to pin 5) of the main controller U3 (belonging to the main control module 210).

A receiving end (RXD) of the wireless receiving circuit 240 is connected to a transmitting end (corresponding to pin 6) of the main controller U3 (belonging to the main control module 210).

The main controller U3 interacts with an external wireless signal through the wireless receiving circuit 240, so as to implement wireless control over the LED module or a fan.

The examples of the present invention have been described above in conjunction with the accompanying drawings, but the present invention is not limited to the specific embodiments described above which are merely illustrative and not limiting. Under the inspiration of the present invention, those skilled in the art can make various forms without departing from the spirit of the present invention and the scope of protection of the claims, all of which belong to the protection of the present invention.

What is claimed is:

1. A direct-current circuit control system with (80 V-260 V) wide voltage input and low voltage output, comprising:
a power supply circuit configured to receive a voltage signal input from a mains supply side and perform rectification, filtering, voltage reduction and voltage stabilization on the input voltage signal to output a first voltage signal; and
a main control circuit configured to output at least four pulse-width modulation (PWM) pulse signals, wherein
the main control circuit at least comprises a direct-current (DC)-direct-current (DC) circuit and a main control module,
an input end of the DC-DC circuit is connected to an output end of the power supply circuit, and is configured to receive the first voltage signal and convert the input first voltage signal into a second voltage signal; wherein
a power input end of the main control module is connected to the output end of the power supply circuit, and is configured to receive the first voltage signal to control the main control module to work to output the PWM pulse signals, and the PWM pulse signals are configured to control work of at least one load.

2. The direct-current circuit control system with (80 V-260 V) wide voltage input and low voltage output according to claim 1,
further comprising a light-emitting diode (LED) control circuit, wherein a power input end of the LED control circuit is connected to the output end of the power supply circuit and is configured to receive the first voltage signal and provide a working voltage for the load;
a first signal input end of the LED control circuit is connected to a signal output end of the main control module and is configured to receive a first PWM pulse signal, and the first PWM pulse signal is configured to regulate the first voltage signal to control brightness or color temperature of an LED module; and
a second signal input end of the LED control circuit is connected to a second signal output end of the main control module and is configured to receive a second PWM pulse signal to control the brightness or color temperature of the LED module.

3. The direct-current circuit control system with (80 V-260 V) wide voltage input and low voltage output according to claim 2, wherein
the LED control circuit comprises a constant-current drive circuit,
a power input end of the constant-current drive circuit is connected to the output end of the power supply circuit and is configured to receive the first voltage signal and provide a working voltage for the load;
a first signal input end of the constant-current drive circuit is connected to a first signal output end of the main control module and is configured to receive the first PWM pulse signal; and
a second signal input end of the constant-current drive circuit is connected to the second signal output end of the main control module and is configured to receive the second PWM pulse signal.

4. The direct-current circuit control system with (80 V-260 V) wide voltage input and low voltage output according to claim 3, wherein
the constant-current drive circuit comprises a first constant-current driver and a second constant-current driver,
power input ends of the first constant-current driver and the second constant-current driver are connected to the output end of the power supply circuit separately and are configured to receive the first voltage signal,
a signal input end of the first constant-current driver is connected to a signal output end of the main control module and is configured to receive the first PWM pulse signal, and
a signal input end of the second constant-current driver is connected to another signal output end of the main control module and is configured to receive the second PWM pulse signal.

5. The direct-current circuit control system with (80 V-260 V) wide voltage input and low voltage output according to claim 4, wherein
the LED control circuit further comprises a switch circuit,
one end of the switch circuit is connected to an output end of the first constant-current driver or the second constant-current driver, and
the other end of the switch circuit is connected to an interface of the LED module.

6. The direct-current circuit control system with (80 V-260 V) wide voltage input and low voltage output according to claim 4, wherein
the main control module at least comprises a main controller,
a first signal output end of the main controller is connected to a signal input end of the first constant-current driver, and
a second signal output end of the main controller is connected to a signal input end of the second constant-current driver.

7. The direct-current circuit control system with (80 V-260 V) wide voltage input and low voltage output according to claims claim 6,
further comprising a motor control circuit,
a signal input end of the motor control circuit is connected to the signal output ends of the main control module separately and is configured to receive a control signal, and
an output end of the motor control circuit is connected to an input end of a motor.

8. The direct-current circuit control system with (80 V-260 V) wide voltage input and low voltage output according to claim 7, wherein
the motor control circuit comprises a current sampling circuit,
a detection end of the current sampling circuit is connected to the signal input end of the motor control circuit, and
an output end of the current sampling circuit is connected to a current feedback end of the main control module.

9. The direct-current circuit control system with (80 V-260 V) wide voltage input and low voltage output according to claims claim 8, wherein
the main control circuit further comprises a voltage detection circuit,
one end of the voltage detection circuit is connected to the output end of the power supply circuit, and
the other end of the voltage detection circuit is connected to a voltage feedback end of the main control module.

10. The direct-current circuit control system with (80 V-260 V) wide voltage input and low voltage output according to claims claim 9, wherein
the main control circuit further comprises a wireless receiving circuit,
a transmitting end of the wireless receiving circuit is connected to a receiving end of the main control module, and
a receiving end of the wireless receiving circuit is connected to a transmitting end of the main control module.
